(19) United States
(12) Patent Application Publication
(10) Pub. No.: US 2021/0079148 A1
(43) Pub. Date: Mar. 18, 2021

(54) SYNTHETIC POLYISOPRENE COPOLYMER AND PRODUCING METHOD THEREFOR

(71) Applicant: Toyo Tire Corporation, Itami-shi, Hyogo (JP)

(72) Inventors: Norihiko Nakamura, Itami-shi (JP); Seiichi Kawahara, Nagaoka-shi (JP)

(73) Assignee: Toyo Tire Corporation, Itami-shi, Hyogo (JP)

(21) Appl. No.: 16/954,382

(22) PCT Filed: Jan. 9, 2018
(86) PCT No.: PCT/JP2018/000217

§ 371 Date: Jun. 16, 2020

(51) Int. Cl. C08F 279/02; C08F 36/08; C08F 2/24; C08F 6/16

(52) U.S. Cl. CPC C08F 279/02; C08F 6/16; C08F 2/24; C08F 36/08

(57) ABSTRACT

A synthetic polyisoprene copolymer is manufactured by stirring a synthetic polyisoprene rubber latex under the heating condition of 50° C. or higher, purifying the latex by centrifugation, adding a vinyl monomer to the purified synthetic polyisoprene rubber latex obtained and graft-copolymerizing the vinyl monomer. The synthetic polyisoprene copolymer is a copolymer in which a vinyl monomer is graft-copolymerized on the surface of synthetic polyisoprene particles, and which has a nanomatirx structure in which the synthetic polyisoprene rubber particles are dispersed in a continuous phase having a thickness of from 1 to 100 nm formed by graft chains in a phase-separated state.

### TECHNICAL FIELD

The present invention relates to a synthetic polyisoprene copolymer and a producing method therefor.

### BACKGROUND ART

As a technique of modifying rubber, it is conventionally known to graft-copolymerize a vinyl monomer such as a styrene monomer or an acryl monomer on a rubber latex (for example, see Patent Literature 1)

Furthermore, a graft copolymer of natural rubber having a nanomatrix structure is known. For example, Patent Literature 2 discloses that a natural rubber graft copolymer having a nanomatrix structure in which natural rubber particles are dispersed in a continuous phase having a thickness of from 1 to 100 nm formed by graft chains in a phase-separated state is obtained by deproteinizing a natural rubber latex and then graft-copolymerizing a vinyl monomer on the surface of natural rubber particles.

### CITATION LIST

### Patent Literature

Patent Literature 1: JP-A-2003-012736

Patent Literature 2: JP-A-2004-155884

### SUMMARY OF INVENTION

### Technical Problem

The present inventors have considered obtaining synthetic polyisoprene copolymer having a nanomatrix structure by using the commercially available synthetic polyisoprene rubber latex in place of a natural rubber latex and graft-copolymerizing a vinyl monomer onto the rubber latex.

However, in the case of using the commercially available synthetic polyisoprene rubber latex, copolymerization between a rubber latex having been purified by centrifugation at room temperature and a vinyl monomer is difficult to proceed, and a synthetic polyisoprene copolymer having a nanomatrix structure cannot be obtained.

In view of the above, an embodiment of the present invention has an object to provide a novel producing method that can graft-copolymerize a vinyl monomer onto a synthetic polyisoprene rubber latex. An embodiment of the present invention further has an object to provide a synthetic polyisoprene copolymer having a nanomatrix structure obtained by the producing method.

### Solution to Problem

The producing method of a synthetic polyisoprene copolymer according to the embodiment of the present invention comprises stirring a synthetic polyisoprene rubber latex under the heating condition of 50° C. or higher, purifying the latex by centrifugation and adding a vinyl monomer to the purified synthetic polyisoprene rubber latex obtained and graft-copolymerizing the vinyl monomer.

The synthetic polyisoprene copolymer according to the embodiment of the present invention is a synthetic polyisoprene copolymer in which a vinyl monomer is graft-copolymerized on the surface of synthetic polyisoprene particles, and which has a nanomatrix structure in which the synthetic polyisoprene rubber particles are dispersed in a continuous phase having a thickness of from 1 to 100 nm formed by graft chains in a phase-separated state.

### Advantageous Effects of Invention

According to the embodiment of the present invention, a vinyl monomer can be graft-copolymerized on the synthetic polyisoprene rubber latex. Furthermore, the synthetic isoprene graft copolymer having a nanomatrix structure can be obtained.

### BRIEF DESCRIPTION OF DRAWINGS

FIG. 1 is a flow chart of producing process of the synthetic polyisoprene copolymer according to Examples 1 to 4.

FIG. 2 is a transmission electron micrograph of the rubber film obtained in Example 4.

FIG. 3 is a graph of a strain-stress curve in a tensile test of rubber films of Example 3 and Comparative Example 1.

FIG. 4 is transmission electron micrographs with 5000 magnifications and 10000 magnifications of the rubber film obtained in Example 5.

FIG. 5 is a graph of a strain-stress curve in a tensile test of the rubber film obtained in Example 5.

### MODE FOR CARRYING OUT THE INVENTION

The items relating to the working of the present invention are described in detail below.

The present inventors have found that in purifying the commercially available synthetic polyisoprene rubber latex prior to copolymerization of the rubber latex and a vinyl monomer, the rubber latex is stirred under heating condition, thereby the rubber latex and the vinyl monomer are easy to be copolymerized. The reason that graft copolymerization proceeds by stirring under the heating conditions is not clear, and although not limited thereby, the reason is considered as follows.

As one hypothesis that copolymerization reaction is difficult to proceed in the case of using the commercially available synthetic polyisoprene rubber latex, it is considered that a rosin surfactant contained in a synthetic isoprene rubber latex covers rubber particles and disturbs a reaction. Specifically, as described in Jyoji Shimosato, et al., “Rosin acid soap in styrene rubber emulsion polymerization”, Organic Synthetic Chemistry, vol. 16, 11 (1958), p 630-636 and additionally as defined in ISO 2303: 2000, a rosin surfactant is unavoidably contained in the commercially available synthetic polyisoprene rubber latex. Because the rosin surfactant has high softening point of about 80° C., it is difficult to remove the rosin surfactant by only purification by centrifugation. The rosin surfactant can be removed from the surface of rubber particles by heating and stirring the rubber latex before centrifugation, and as a result, it is considered that the graft copolymerization is easy to proceed.

(Raw Material Latex)

In the producing method according to this embodiment, a rubber latex containing cis-1,4-polyisoprene rubber can be used as a synthetic polyisoprene rubber (IR) latex (hereinafter merely referred to as “IR latex”) as a starting raw material.

As one embodiment, for example, the commercially available IR latex may be used as IR latex. The commercially available IR latex is synthesized using a rosin surfactant as an emulsifier. Therefore, a rosin surfactant is contained in the IR latex. For this reason, it is considered that the effect of this embodiment is easy to be exhibited. Examples of the rosin surfactant include rosin acid soap, disproportionated rosin acid soap and the like. The amount of the rosin surfactant contained in the IR latex is not particularly limited. For example, the amount may be from 0.05 to 2 parts by mass per 100 parts by mass of the synthetic isoprene rubber.

(Purification of IR Latex)

In this embodiment, the IR latex is purified by stirring under the heating condition of 50° C. or higher and subjecting to centrifugation. By heating and stirring the IR latex at 50° C. or higher, the copolymerization with a vinyl monomer can make easy to proceed.

The heating condition, that is, a heating temperature when stirring the IR latex, is preferably 60° C. or higher. As described in the examples described hereinafter, the reaction rate of the copolymerization reaction tends to decrease at 80° C. Therefore, the heating condition is preferably 60° C. or higher and 70° C. or lower, or 85° C. or higher and lower than 100° C., and more preferably 85° C. or higher and 95° C. or lower.

The stirring time when stirring the IR latex is not particularly limited. For example, the stirring time may be from 10 to 200 minutes and may be from 20 to 120 minutes. Furthermore, the stirring condition is not particularly limited. For example, the IR latex may be stirred at from 50 to 1000 rpm and may be stirred at from 100 to 500 rpm, using a stirring machine having stirring blades that can stir a rubber latex.

The concentration of the IR latex when stirring the IR latex is not particularly limited. For example, the concentration may be from 10 to 60 mass % and may be from 20 to 50 mass %, in terms of a rubber concentration (DRC: Dry Rubber Content).

When stirring the IR latex, a surfactant that does not disturb copolymerization reaction with a vinyl monomer may be added to the IR latex. Examples of the surfactant that can be used include various anionic surfactants, nonionic surfactants and cationic surfactants exemplified below.

Examples of the anionic surfactant include carboxylic acid type, sulfonic acid type, sulfuric acid ester type, phosphoric acid ester type and the like.

Examples of the carboxylic acid type anionic surfactant include carboxylic acid salts having from 6 to 30 carbon atoms, such as fatty acid salt, polycarboxylic acid salt, dimer acid salt, polymer acid salt, tall oil fatty acid salt and the like. Above all, carboxylic acid salts having from 10 to 20 carbon atoms are preferred. When the number of carbon atoms of the carboxylic acid type anionic surfactant is 6 or more, dispersion and emulsification effects of proteins and impurities can be improved, and when the number of carbon atoms is 30 or less, the IR latex can be easily dispersed in water.

Examples of the sulfonic acid type anionic surfactant include alkylbenzene sulfonic acid salt, alkyl sulfonic acid salt, alkyl naphthalene sulfonic acid salt, naphthalene sulfonic acid salt, diphenyl ether sulfonic acid salt and the like.

Examples of the sulfuric acid ester type surfactant include alkyl sulfuric acid ester salt, polyoxyalkylene alkyl sulfuric acid ester salt, polyoxyalkylene alkyl phenyl ether sulfuric acid salt, tristyrenated phenol sulfuric acid ester salt, polyoxyalkylene distyrenated phenol sulfuric acid ester salt and the like.

Examples of the phosphoric acid ester type anionic surfactant include alkyl phosphoric acid ester salt, polyoxyalkylene phosphoric acid ester salt and the like.

Examples of the salt of the compound in the anionic surfactant include metal salt (Na, K, Ca, Mg, Zr and the like), ammonium salt, amine salt (triethanolamine and the like) and the like.

Examples of the nonionic surfactant include polyoxyalkylene ether type, polyoxyalkylene ester type, polyhydric alcohol fatty acid ester type, sugar fatty acid ester type, alkyl polyglycoside type and the like.

Examples of the polyoxyalkylene ether type nonionic surfactant include polyoxyalkylene alkyl ether, polyoxyalkylene alkyl phenyl ether, polyoxyalkylene polyol alkyl ether, polyoxyalkylene styrenated phenol ether, polyoxyalkylene distyrenated phenol ether, polyoxyalkylene tristyrenated phenol ether and the like. Examples of the polyol include polyhydric alcohols having from 2 to 12 carbon atoms, and specifically include propylene glycol, glycerin, sorbitol, sucrose, pentaerythritol, sorbitan and the like.

Example of the polyoxyalkylene ester type nonionic surfactant include polyoxyalkylene fatty acid ester and the like. Examples of the polyhydric alcohol fatty acid ester type nonionic surfactant include fatty acid ester of polyhydric alcohol having from 2 to 12 carbon atoms and fatty acid ester of polyoxyalkylene polyhydric alcohol. More specifically, examples thereof include sorbitol fatty acid ester, sorbitan fatty acid ester, fatty acid monoglyceride, fatty acid diglyceride, polyglycerin fatty acid ester and the like. Furthermore, polyoxyalkylene oxide adducts (for example, polyoxyalkylene sorbitan fatty acid ester and polyoxyalkylene glycerin fatty acid ester) of those can be used.

Examples of the sugar fatty acid ester type nonionic surfactant include fatty acid esters of sucrose, glucose, maltose, fructose and polysaccharides. Polyalkylene oxide adducts of those can be used.

Examples of the alkyl polyglycoside type nonionic surfactant include alkyl glucoside, alkyl polyglucoside, polyoxyalkylene alkyl glucoside, polyoxyalkylene alkyl polyglucoside and the like, and further include fatty acid esters of those. Furthermore, polyalkylene oxide adducts of those can be used.

Examples of the alkyl group in the nonionic surfactant include an alkyl group having from 4 to 30 carbon atoms. Examples of the polyoxyalkylene group include an alkylene group having from 2 to 4 carbon atoms. For example, polyoxyalkylene groups in which the number of moles added of ethylene oxides is from about 1 to 50 mol are exemplified. Examples of the fatty acid include linear or branched saturated or unsaturated fatty acid having from 4 to 30 carbon atoms.

Examples of the cationic surfactant include alkylamine salt type, alkylamine derivative type and their quaternized products, imidazolium salt type and the like.

Examples of the alkylamine salt type cationic surfactant include salts of primary amine, secondary amine and tertiary amine. The alkylamine derivative type cationic surfactant has at least one of an ester group, an ether group and an amide group in the molecule, and examples thereof include polyoxyalkylene (AO) alkylamine and its salt, alkyl ester amine (including AO adduct) and its salt, alkyl ether amine (including AO adduct) and its salt, alkyl amide amine (including AO adduct) and its salt, alkyl ester amide amine (including AO adduct) and its salt, and alkyl ether amide amine (including AO adduct) and its salt. The kind of the salt includes, for example, hydrochloric acid salt, phosphoric acid salt, acetic acid salt, alkylsulfuric acid ester, alkylbenzene sulfonic acid, alkylnaphthalene sulfonic acid, fatty acid, organic acid, alkyl phosphoric acid ester, alkylether carboxylic acid, alkylamide ether carboxylic acid, anionic oligomer and anionic polymer. Of the alkylamine derivative type cationic surfactants, specific examples of acetic acid salt include, for example, coconut amine acetate and stearyl amine acetate. The alkyl group in the alkylamine salt type and alkylamine derivative type cationic surfactants is not particularly limited, and generally includes straight chain, branched chain or Guerbet-like alkyl groups having from 8 to 22 carbon atoms.

Examples of the quaternized products of the alkylamine salt type and alkylamine derivative type cationic surfactants include products obtained by quaternizing the alkylamine salt and alkylamine derivative with, for example, methyl chloride, methyl bromide, dimethylsulfuric acid or diethylsulfuric acid. Specifically, alkyl trimethyl ammonium halides such as lauryl trimethylammonium halide, cetyl trimethylammonium halide and stearyl trimethylammonium halide; dialkyl dimethylammonium halides such as distearyl dimethylammonium halide; trialkyl methylammonium halide; dialkyl benzyl methylammonium halide; and alkyl benzyl dimethylammonium halide are exemplified.

Examples of the imidazolinium salt type cationic surfactant include 2-heptadecenyl-hydroxyethyl imidazoline and the like.

The above-exemplified surfactants may be used in one kind alone or as mixtures of two or more kinds. Of the above-exemplified surfactants, examples of the surfactants particularly showing stable surface activity in a pH range of from 6.5 to 8.5 include polyoxyethylene nonyl phenyl ether as a nonionic surfactant and polyoxyethylene alkyl phenyl ether sodium sulfate as an anionic surfactant.

The amount of the surfactant added may be from 0.01 to 3 mass % and may be from 0.05 to 2 mass %, in terms of a concentration in the IR latex.

By conducting centrifugation after heating and stirring as described above, the IR latex is separated into a cream content containing synthetic polyisoprene rubber and a serum content as a serum. When water is added to the cream content obtained to re-disperse the cream content in water, purified synthetic polyisoprene rubber latex (purified IR latex) is obtained.

The heating and stirring and the centrifugation may be repeatedly conducted several times. Specifically, after heating and stirring the IR latex and conducting centrifugation, water and a surfactant are added to the cream content when re-dispersing the cream content, followed by stirring under the heating conditions described above, centrifugation is then conducted, and this operation may be repeated several times. The repeating number is not particularly limited, and for example, the heating and stirring and the centrifugation may be carried out from 2 to 5 times.

The conditions for centrifuging the IR latex are not particularly limited so long as the IR latex can be separated into a cream content and a serum content. For example, centrifugal acceleration may be from 5000 to 50000G (that is, from 49000 to 490000 m/s²) and may be from 7000 to 30000G (that is, from 68600 to 294000 m/s²). Furthermore, the centrifugation time may be from 10 to 60 minutes and may be from 20 to 40 minutes. The temperature in conducting centrifugation may be from 10 to 40° C. and may be from 20 to 35° C.

The concentration of the purified IR latex that is prepared as above is not particularly limited. For example, the concentration may be from 10 to 60 mass % and may be from 20 to 50 mass %, in terms of rubber concentration (DRC). Furthermore, the above-described various surfactants may be added to the purified IR latex as a surfactant that does not disturb copolymerization reaction with a vinyl monomer. The amount of the surfactant added may be from 0.01 to 3 mass % and may be from 0.05 to 2 mass %, in terms of a concentration in the purified IR latex.

(Graft Copolymerization) In this embodiment, a vinyl monomer is added to the purified IR latex obtained above to graft-copolymerize the vinyl monomer. To graft the vinyl monomer on the surface of the synthetic polyisoprene rubber particles contained in the purified IR latex, the vinyl monomer is added to the purified IR latex, additionally an appropriate polymerization initiator is added, and reaction is conducted.

The vinyl monomer is not particularly limited so long as it can be grafted on the surface of the synthetic polyisoprene rubber particles. Examples of the vinyl monomer include styrene monomers such as styrene, alkylstyrene (for example, methylstyrene, ethylstyrene, propylstyrene, butylstyrene and pentylstylene) and the like; vinyl alkoxysilane monomers such as vinyl triethoxysilane, vinyl trimethoxysilane, vinyl tris(2-methoxyethoxy)silane and vinyl methyl dimethoxysilane; (meth)acrylic acid monomers such as (meth)acrylic acid, methyl (meth)acrylate and 2-hydroxyethyl (meth)acrylate; (meth)acryl amide monomers such as (meth)acrylamide and alkyl (meth)acrylamide; vinyl ester monomers such as vinyl acetate; nitrile vinyl monomers such as acrylonitrile; and vinylpyrrolidone. Those may be used in one kind and may be used as mixtures of two or more kinds. The “(meth)acrylic acid” used herein means one of acrylic acid and methacrylic acid or both, the (meth)acrylate” means one of acrylate and methacrylate or both, and the “(meth)acrylamide” means one of acrylamide and methacrylamide or both.

The amount of the vinyl monomer added is not particularly limited, but is preferably from 5 to 30 parts by mass and more preferably from 10 to 20 parts by mass, per 100 parts by mass of the synthetic polyisoprene rubber. When the vinyl monomer is added in such an amount, the amount of the vinyl monomer grafted is secured, thereby increasing improvement effect, and additionally, formation of a homopolymer is suppressed and graft efficiency can be enhanced.

Examples of the polymerization initiator include peroxides such as benzoyl peroxide, hydrogen peroxide, cumene hydroperoxide, tert-butyl hydroperoxide, di-tert-butyl peroxide, 2,2-azobisisobutylronitrile, potassium persulfate and the like. Redox type polymerization initiator is particularly preferred in lowering a polymerization temperature. Examples of reducing agent to be combined with a peroxide in the Redox type polymerization initiator include tetraethylene pentamine, mercaptanes, acidic sodium sulfite, reducing metal ion, ascorbic acid and the like. Examples of the combination in the Redox type polymerization initiator include tert-butyl hydroxyperoxide and tetraethylene pentamine, hydrogen peroxide and Fe′ salt, and K₂SO₂O₈ and NaHSO₃. The amount of the polymerization initiator added is not particularly limited, and, for example, may be from 0.3 to 10 mol % per 100 mol of the vinyl monomer.

The purified IR latex, vinyl monomer and polymerization initiator are charged in a reaction vessel, and a reaction is conducted at from 25 to 80° C. for from 1 to 10 hours. As a result, a latex containing synthetic polyisoprene copolymer in which a vinyl monomer is graft-copolymerized on the surface of synthetic polyisoprene rubber particles is obtained.

Methanol is added to the latex obtained and the latex is coagulated. As a result, solid synthetic polyisoprene copolymer can be recovered. Alternatively, a film (that is, a sheet or film) of the synthetic polyisoprene copolymer may be prepared by cast molding using the latex.

(Synthetic Polyisoprene Copolymer)

The synthetic polyisoprene copolymer according to this embodiment obtained by the above is a copolymer in which a vinyl monomer is graft-copolymerized on the surface of synthetic polyisoprene rubber particles, and is also called synthetic polyisoprene graft copolymer. The synthetic polyisoprene copolymer has a nanomatrix structure in which the synthetic polyisoprene rubber particles are dispersed in a continuous phase having a thickness of from 1 to 100 nm formed by graft chains in a phase-separated state.

The synthetic polyisoprene copolymer according to this embodiment may consist of only the synthetic polyisoprene copolymer having a nanomatrix structure, but may contain a homopolymer comprising the vinyl monomer together with the synthetic polyisoprene copolymer. In other words, in the graft copolymerization, not only the graft copolymer but a homopolymer is generally formed from the vinyl monomer. Therefore, the synthetic polyisoprene copolymer may be a mixture containing the homopolymer in a mixed state. Therefore, the polymer obtained by the manufacturing method can be a rubber material containing the synthetic polyisoprene copolymer. The rubber material used herein means a rubber that is used as a material when manufacturing a rubber product.

In the synthetic polyisoprene copolymer having the nanomatrix structure, the particle diameter of the synthetic polyisoprene rubber particles depends on the particle diameter of the IR latex as the raw material and is not particularly limited. The average particle diameter may be from 0.01 to 20 μm and may be from 0.04 to 3.0 μm. The average particle diameter used herein is obtained as arithmetic mean by measuring diameters of 100 particles randomly extracted from an image of a transmission electron microscope (TEM). The particle diameter of the particles can be an average value of values obtained by measuring a diameter connecting two points on the outer periphery of a particle and passing a center of gravity of the particle in increments of 2°. When the particle diameter of the synthetic polyisoprene rubber particles is measured using the IR latex as a raw material, the value of D50 measured using a laser diffraction particle size analyzer is used.

In the nanomatrix structure, the graft chain that is a polymer of vinyl monomer forms a continuous phase (that is, matrix phase) having a thickness of from 1 to 100 nm. The continuous phase is interposed between the synthetic polyisoprene rubber particles and phase-separates those rubber particles. The continuous phase is formed in a layer shape between the rubber particles. The thickness of the continuous phase is from 1 to 100 nm. Because the thickness is namometer order, the continuous phase can be called a nanomatrix phase. The thickness of the continuous phase is more preferably from 5 to 50 nm. The thickness of the continuous phase is obtained as an arithmetic mean by measuring thickness of graft chains formed between the rubber particles of 100 pairs randomly extracted from an image of a transmission electron microscope (TEM).

In the synthetic polyisoprene copolymer, the content of the graft chain comprising the vinyl monomer is not particularly limited. For example, the content may be from 3 to 30 mass %, may be from 5 to 25 mass % and may be from 8 to 20 mass %. The content of the graft chain used herein is the proportion of mass of the graft chain moiety based on the mass of the whole synthetic polyisoprene copolymer.

In one embodiment, when forming a film of the synthetic polyisoprene copolymer, the thickness of the film is not particularly limited. For example, the thickness may be from 10 to 1000 μm and may be from 10 to 500 μm.

The synthetic polyisoprene copolymer according to this embodiment has the nanomatirx structure in which a vinyl monomer is graft-copolymerized. Therefore, the copolymer has excellent properties of the synthetic polyisoprene rubber and additionally can have enhanced breaking strain and breaking strength as compared with unmodified synthetic polyisoprene rubber.

Uses of the synthetic polyisoprene copolymer according to this embodiment are not particularly limited, and can be used as a material of tires such as a pneumatic tire, anti-vibration rubbers, and various rubber products in medical field and household articles such as a condom or rubber gloves.

### EXAMPLES

The synthetic polyisoprene copolymer and its producing method are specifically described below by examples, but the present invention is not construed as being limited to those examples.

### Example 1

Cis-1,4-polyisoprene rubber latex ME1100 (TSC (total solid content): about 56. 4 mass %) manufactured by Zeon Corporation was used as raw material IR latex. Furthermore, a material obtained by cleaning styrene with 10 mass % sodium hydroxide aqueous solution three times and then cleaning the styrene with distilled water until becoming neutral was used as a vinyl monomer.

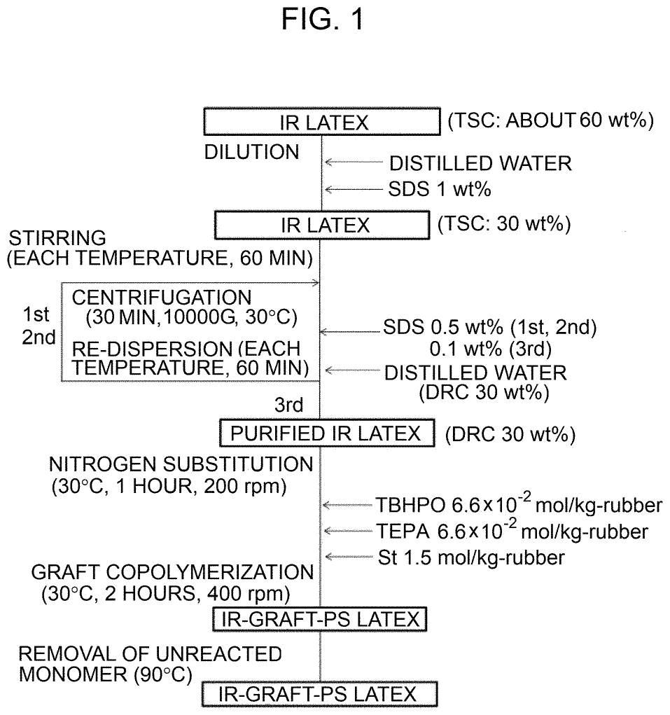

According to the procedures shown in FIG. 1, the IR latex was purified and graft copolymerization of styrene was conducted. The details are as follows.

Sodium dodecyl sulfate (SDS) (Grade 1, manufactured by Kishida Chemical Co., Ltd.) and distilled water were added to the raw material IR latex, thereby the concentration of SDS was adjusted to 1 mass % and TSC was adjusted to 30 mass %. Stirring temperature was set to 50° C., and the obtained IR latex having TSC of 30 mass % was stirred under ordinary pressure at 200 rpm for 60 minutes using a stirring machine. Thereafter, the IR latex was subjected to centrifugation (10000G 30° C., 30 minutes) to separate into a cream content and a serum content. Distilled water and SDS were added to the cream content, and the cream content was re-dispersed such that the concentration of SDS is 0.5 mass % and DRC is 30 mass %. The IR latex obtained was stirred under ordinary pressure at 50° C. and 200 rpm for 60 minutes, and then subjected to centrifugation (10000G, 30° C., 30 minutes). The re-dispersion, heating and stirring, and centrifugation were repeated once again. Thereafter, distilled water and SDS were added to the cream content obtained by the final centrifugation, and the cream content was re-dispersed such that the concentration of SDS is 0.1 mass % and DRC is 30 mass %. Thus, purified IR latex was obtained.

The purified IR latex was subjected to nitrogen substitution for 1 hour while stirring at 30° C. and 200 rpm. Thereafter, as a polymerization initiator, tert-butyl hydroperoxide (TBHPO) (purity 67%, manufactured by Kishida Chemical Co., Ltd.) and tetraethylene pentaamine (TEPA) (content 95%, manufactured by Kishida Chemical Co., Ltd.) were sequentially added dropwise to 1 kg of the rubber in the IR latex, respectively, in each amount of 6.6×10⁻² mol. Furthermore, 1.5 mol of styrene was added dropwise to 1 kg of the rubber in the IR latex. Polymerization reaction was conducted at 30° C. and 400 rpm in nitrogen atmosphere for two hours. After completion of the reaction, unreacted styrene monomer was removed from the latex at 90° C. using a rotary evaporator. Thus, a latex containing synthetic polyisoprene copolymer (IR-graft-PS latex) was obtained. Thereafter, the rubber content remained in a reaction apparatus was coagulated with methanol and recovered. Thus, synthetic polyisoprene copolymer was obtained.

### Examples 2 to 4

Synthetic polyisoprene copolymers were obtained in the same manner as in Example 1, except that the stirring temperature in the purification step of the IR latex was changed to 65° C. in Example 2, 80° C. in Example 3 and 90° C. in Example 4, as shown in Table 1 below.

(Styrene Content, Styrene Reaction Rate and Graft Efficiency)

Styrene content, styrene reaction rate and graft efficiency in Examples 1 to 4 are shown in Table 1. Calculation formulae of the styrene content and styrene reaction rate are as follows.

Styrene content (mass %)=[(Mass of all solid after reaction (g)−Mass of all solid before reaction (g))/Mass of all solid after reaction (g)]×100

Styrene reaction rate (mass %)=[(Mass of all solid after reaction (g)−Mass of all solid before reaction (g))/Amount of monomer charged (g)]×100

The graft efficiency was obtained as follows. It was confirmed by FT-IR and NMR measurements that some samples were grafted. The latex containing the synthetic polyisoprene copolymer was cast on a petri dish and vacuum dried for 1 week, and an as-cast film having a thickness of 1 mm was obtained. About 1 g of the as-cast film obtained was finely cut into a size of about 1 mm square, and extraction was conducted for 24 hours by refluxing acetone/2-butanone mixed solution (3:1) in nitrogen atmosphere using Soxhlet extractor while shielding light. By the extraction, soluble styrene homopolymer was removed from insoluble graft copolymer. The graft efficiency was calculated by the following calculation formula. In the formula, Wb is mass of a sample before Soxhlet extraction (g), Wa is mass of a sample after Soxhlet extraction (g) and Ym is styrene content (g).

$$Graft efficiency ( mass \% ) = \frac{W b \times \frac{Ym}{100} - ( W b - Wa )}{W b \times Ym / 100} \times 100$$

TABLE 1

| | Stirring | Styrene | Styrene | Graft |
|---|---|---|---|---|
| | temperature | content | reaction rate | efficiency |
| | [° C.] | [mass %] | [mass %] | [mass %] |
| Example 1 | 50 | 5.37 | 36.38 | 15.0 |
| Example 2 | 65 | 8.60 | 60.18 | 50.1 |
| Example 3 | 80 | 4.72 | 31.70 | 10.8 |
| Example 4 | 90 | 10.88 | 78.42 | 57.1 |

As shown in Table 1, it is understood that the purified IR latex stirred at higher temperature shows higher reaction rate and graft efficiency. It is considered from the results that when the IR latex is stirred at high temperature in the purification step, a rosin surfactant contained in the IR latex can be removed. Furthermore, when the stirring temperature is 90° C., the highest reaction rate and graft efficiency are shown, and synthetic isoprene graft copolymer in which 57.1 mass % of styrene was graft-reacted could be obtained.

When the stirring temperature is 80° C., the reaction rate was low as compared with the case of 50° C. The reason is not clear, but since a softening point of rosin acid is about 80° C., the possibility that some kind of reaction occurs at a softening point is considered. From the result, it can be said that as the heating condition, the temperature is more preferably 50° C. or higher and 70° C. or lower, or 85° C. or higher and lower than 100° C.

(Morphological Observation)

A predetermined glass mold was dipped in the latex containing each of the synthetic polyisoprene copolymers obtained in Examples 1 to 4, and heated and dried, thereby preparing a rubber film (cast film) having a thickness of about 1 mm. The rubber film obtained was dyed with OsO₄, an ultrathin cut piece was prepared using a cryomicrotome (Ultracut N manufactured by Reichert-Nissi), and phase separation structure was observed with a transmission electron microscope (TEM, JEM-2100 manufactured by JEOL, accelerated voltage 200 kV).

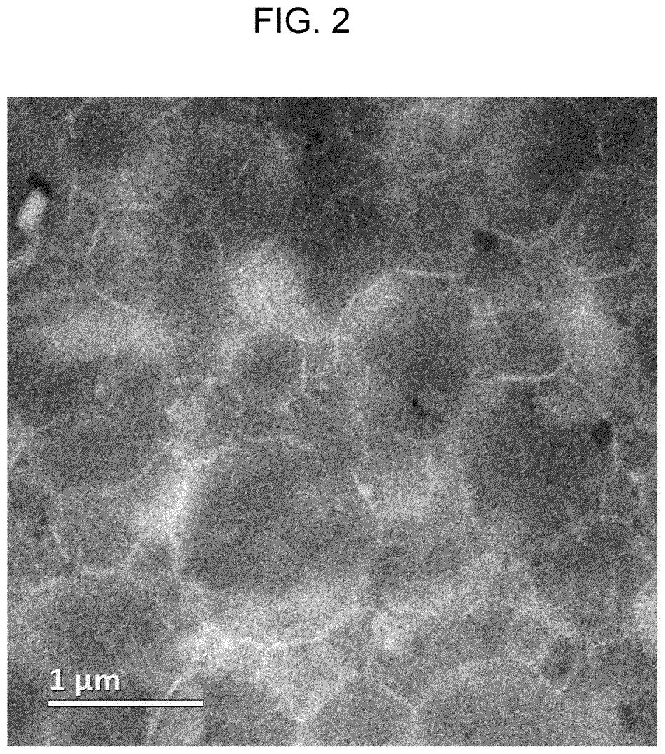

As a result, in the rubber films of Examples 1 to 4, the synthetic polyisoprene rubber particles are phase-separated from polystyrene grafted, the synthetic polyisoprene rubber particles having a diameter of about 1 μm are dispersed in a graft styrene continuous phase having a thickness of from several nm to several tens of nm, and phase separation state between the graft styrene continuous phase and the synthetic polyisoprene rubber particle dispersed phase was observed. FIG. 2 is a transmission electron micrograph of the rubber film obtained in Example 4. Black phase shows synthetic polyisoprene rubber particles, and white phase shows polystyrene.

(Tensile Test) Tensile test (monoaxial elongation test) according to JIS K6251 was conducted on the rubber film of Example 3 prepared above and the rubber film (Comparative Example 1) prepared from the raw material IR latex, and the relationship between tensile strain and tensile stress was examined. In Comparative Example 1, raw material IR latex was used as the latex, and a rubber film (cast film) having a thickness of about 1 mm was prepared by dipping a predetermined glass mold in the raw material IR latex, followed by heating and drying, as same as in Example 3.

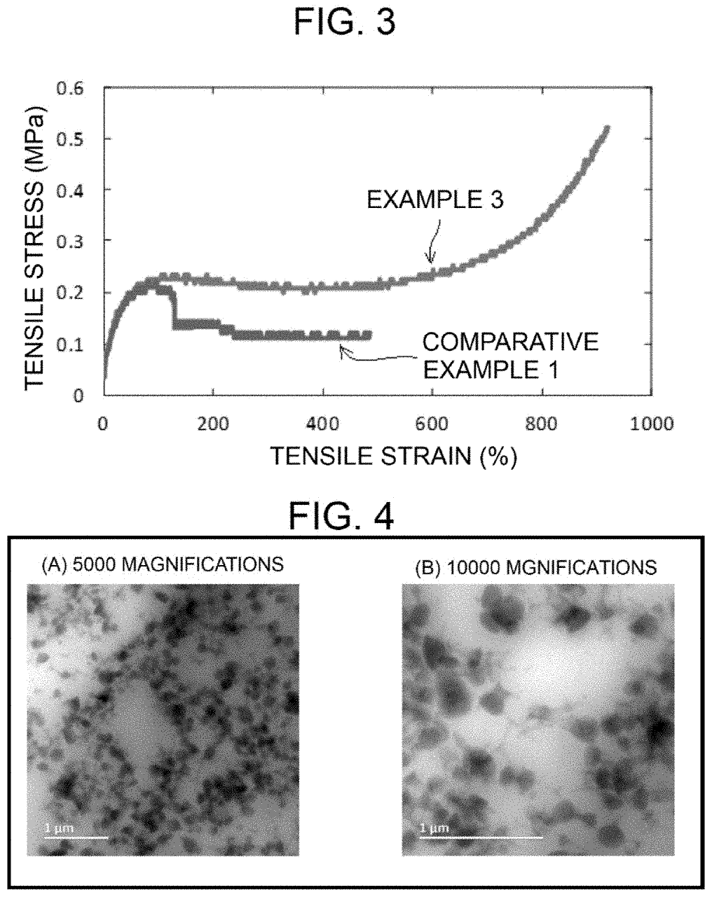

The results of the tensile test are shown in FIG. 3. The tensile test was conducted on Example 3 and Comparative Example 2 five times, respectively, and an average value of five times was calculated in tensile stress when breaking (breaking stress) and tensile strain when breaking (breaking strain). FIG. 3 shows a strain-stress curve of one tensile test in five tensile tests.

As a result, in Comparative Example 1, the breaking stain and breaking stress were 850% and 0.12 MPa, respectively. On the other hand, in Example 3, the breaking stain and breaking stress were 1000% and 0.52 MPa, respectively, and those values were higher than the values of Comparative Example 1. It was understood from this result that the breaking strain and breaking strength of the synthetic polyisoprene rubber are increased by that styrene is graft-copolymerized on the synthetic polyisoprene rubber, thereby forming the nanomatrix structure.

In the strain-stress curve of Comparative Example 1, the tensile stress greatly dropped in the vicinity of strain 150%, whereas in Example 3, the tensile stress did not drop and properties were greatly changed depending on the presence or absence of the formation of the nanomatrix structure.

### Example 5

Vinyl triethoxysilane (VTES) that is a silicon-containing vinyl monomer was used as a vinyl monomer, and the vinyl monomer was tried to graft-copolymerize to the synthetic polyisoprene rubber latex. Vinyl triethoxysilane forms silica by polymerization. Therefore, the nanomatrix structure obtained by the graft copolymerization becomes a nanophase-separated structure formed by dispersing synthetic polyisoprene rubber particles having an average particle diameter of about 1 μm in a matrix having a thickness of from several nm to several tens nm filled with silica nanoparticles. Preparation of synthetic polyisoprene graft copolymer having the silica nanomatrix structure (IR-graft-PVTES) was tried.

The stirring temperature was 80° C. as same as in Example 3, and purified IR latex was obtained (however, DRC was 20 mass %). The purified IR latex was put in a separable flask, nitrogen substitution was conducted for 30 minutes, and the nitrogen substitution was further conducted for 30 minutes while stirring at 200 rpm. While stirring at 200 rpm in nitrogen atmosphere, 6.6×10⁻² mol of each of tert-butyl hydroperoxide (TBHPO) (purity 67%, manufactured by Kishida Chemical Co., Ltd.) and tetraethylene pentaamine (TEPA) (content 95%, manufactured by Kishida Chemical Co., Ltd.) as a polymerization initiator was sequentially dropwise added to 1 kg of the rubber in the IR latex. Furthermore, 1.05 mol of vinyl triethoxysilane (VTES) monomer was added dropwise to 1 kg of the rubber in the IR latex, and polymerization was conducted at 30° C. for 2 hours. After completion of the reaction, unreacted monomer was removed at 80° C. under reduced pressure, and the latex was cast on a petri dish, air-dried and then dried at 50° C. under reduced pressure. Thus, a film of synthetic polyisoprene-polyvinyl triethoxysilane graft copolymer (IR-graft-PVTES) was formed.

The monomer reaction rate and the silica content of the IR-graft-PVTES sample prepared were calculated by the following calculation formulae.

Monomer reaction rate (%)=[(Mass of all solid after reaction−Mass of all solid before reaction)/Amount of monomer charged]×100%

Ash content (mass %): Rm=(Mass of ash after heating/Mass of rubber before heating)×100%

Silica content (mass %)=[(Mass of all solid after heating−Mass of rubber before heating×Rm/100)/Amount of rubber before heating]×100%

The ash content is the content of ash contained in the film (IR sample) prepared from the purified IR latex. 1 g of the IR sample was finely cut, transferred to a crucible reached constant weight, and heated with low flame using a gas burner without a lid. When white smoke did not rise, a lid was put on the crucible. After strongly heating for about 30 minutes, strong heating was repeated until reaching constant weight. The ash content of the IR sample was calculated from the weight of the residue obtained (mass of ash after heating). The silica content in the IR-graft-PVTES sample was calculated by subtracting the ash content of the IR sample from the weight of a residue of the IR-graft-PVTES sample (all solid mass after heating) obtained in the same manner as in the IR sample.

As a result, the monomer reaction rate of the IR-graft-PVTES sample obtained in Example 5 was 50%, and the silica content was 5.66 mass %.

The gel content of the IR sample and IR-graft-PVTES sample was measured. 40 mg of the sample was weighed, dipped in 40 ml of dry toluene and allowed to stand in a dark place for one week. Thereafter, the sample was centrifugally separated at 10,000G for 30 minutes, and toluene insoluble content (gel content) was separated from toluene soluble content (sol content). The gel content was dried under reduced pressure for one week and precisely weighed. The gel content was calculated from the following calculation formula.

Gel content (%)=(Mass of gel content/Mass of rubber before dipping)×100%

As a result, the gel content of the IR sample as a raw material was 3.58%. On the other hand, the gel content of the IR-graft-PVTES sample was 18.17% and was greatly increased. This is considered due to that a monomer was grafted on rubber particles and the rubber particles were crosslinked.

Ultrathin cut piece of the IR-graft-PVTES sample was prepared using a cryomicrotome (Ultracut N manufactured by Reichert-Nissi), and morphology observation was conducted with a transmission electron microscope (TEM, JEM-2100 manufactured by JEOL, accelerated voltage 200 kV). FIG. 4 shows TEM images of the IR-graft-PVTES sample photographed with 5000 magnifications and 10000 magnifications. In the images, white region is a rubber phase and black region is a silica phase. In the image (A) of 5000 magnifications, clear nanomatrix structure could not be confirmed on the whole, but it could be observed that a part of silica particles is present around the rubber particles. It is considered that the silica particles are probably a bulk of ungrafted homopolymer. In the image (B) of 10000 magnifications, it is seen that a thin aggregate layer formed by silica particles having a diameter of several nm is somewhat present between the rubber particles and is silica of the graft chains constituting a matrix.

Tensile test of the IR-graft-PVTES sample was conducted according to JIS K6251 using STROGRAPH VG10E manufactured by Toyo Seiki-Seisaku-Sho, Ltd. The IR-graft-PVTES sample was punched with dumbbell shape No. 7 and subjected to a tensile test at room temperature in tensile rate of 200 mm/min.

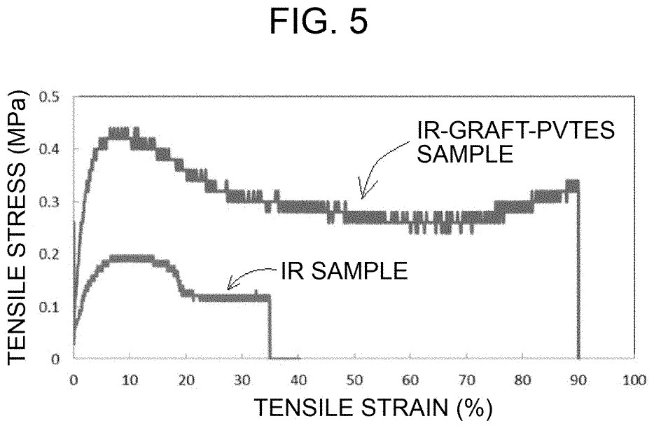

FIG. 5 shows stress-strain curves of the IR sample and IR-graft-PVTES sample. Those samples are not vulcanized. Therefore, molecular chains flowed when pulled, and as a result, smooth curves were not obtained. Furthermore, breaking stress was too low and a tester did not sense even though the test piece was cut. As a result, sure breaking stress could not be measured. However, the stress-strain curve of the IR-graft-PVTES sample exceeded that of the IR sample on the whole. The stress of the IR-graft-PVTES sample was about 2 times higher than the stress of the IR sample at constant strain. Furthermore, seeing the curves in the rising part, elastic modulus of the IR-graft-PVTES sample was higher than that of the IR sample. This is considered to be due to that reinforcing effect was shown to a certain extent by the formation of a small amount of nanomatrix and the filling of silica particles as was understood from the TEM image.

Some embodiments of the present invention are described above, but those embodiments are merely shown as examples and are not intended to limit the scope of the invention. Those embodiments can be carried out in other various forms, and various omissions, replacement and changes can be made in a range that does not deviate the gist of the invention. Those embodiments and their omissions, replacement and changes are included in the scope and gist of the invention, and additionally included in the inventions recited in the scope of claims and their equivalent scopes.

1. A producing method of a synthetic polyisoprene copolymer, which comprises:
stirring a synthetic polyisoprene rubber latex under the heating condition of 50° C. or higher and purifying the latex by centrifugation, and
adding a vinyl monomer to the purified synthetic polyisoprene rubber latex obtained and graft-copolymerizing the vinyl monomer.

2. The producing method according to claim 1, wherein the synthetic poly-isoprene rubber latex is a synthetic polyisoprene rubber latex containing a rosin surfactant.

3. The producing method according to claim 1, wherein the vinyl monomer comprises at least one selected from the group consisting of a styrene monomer and a vinyl alkoxysilane monomer.

4. The producing method according to claim 1, wherein the heating condition is 60° C. or higher and 70° C. or lower, or 85° C. or higher and lower than 100° C.

5. A synthetic polyisoprene copolymer comprising synthetic polyisoprene particles and a vinyl monomer graft-copolymerized on a surface thereof, the copolymer having a nanomatirx structure in Which the synthetic polyisoprene rubber particles are dispersed in a continuous phase having a thickness of from 1 to 100 nm formed by graft chains in a phase-separated state.

6. The synthetic polyisoprene copolymer according to claim 5, wherein the vinyl monomer is at least one selected from the group consisting of a styrene monomer and a vinyl alkoxysilane monomer.
